(19) United States
(12) Patent Application Publication
(10) Pub. No.: US 2012/0056422 A1
(43) Pub. Date: Mar. 8, 2012

(54) PIPE CONNECTION FOR CONNECTING PIPES OF A MOTOR VEHICLE, EXHAUST SYSTEM, AIR INTAKE SYSTEM AND MOTOR VEHICLE

(75) Inventor: Manuel FRIEDL, Ruesselsheim (DE)

(73) Assignee: GM GLOBAL TECHNOLOGY OPERATIONS LLC, Detroit, MI (US)

(21) Appl. No.: 13/227,086

(22) Filed: Sep. 7, 2011

(30) Foreign Application Priority Data
Sep. 8, 2010 (DE) 102010044763.3

(51) Int. Cl. F16L 25/04; F16L 15/00

(52) U.S. Cl. 285/386; 285/390

(57) ABSTRACT

A pipe connection is provided for connecting pipes of a motor vehicle, particularly exhaust pipes for an exhaust system or intake pipes for the intake tract of a combustion engine, with two pipes to be connected to each other. It is provided that at least one of the pipes has a thread which can be brought into engagement with a mating thread of a connecting element of the pipe connection to be connected to the other pipe. An exhaust system is provided for a motor vehicle and an air intake system is provided for a motor vehicle and a motor vehicle.

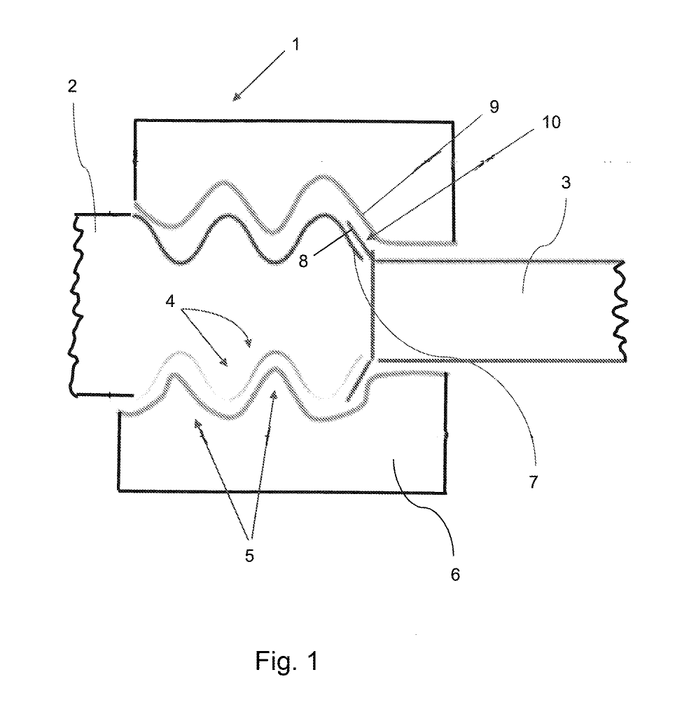

### CROSS-REFERENCE TO RELATED APPLICATION

This application claims priority to German Patent Application No. 102010044763.3, filed Sep. 8, 2010, which is incorporated herein by reference in its entirety.

### TECHNICAL FIELD

The technical field relates to a pipe connection for connecting pipes of a motor vehicle, particularly of exhaust pipes for an exhaust system or intake pipes for the intake tract of a combustion engine. The invention furthermore relates to an exhaust system as well as an air intake system for a motor vehicle. In addition, the invention relates to a motor vehicle.

### BACKGROUND

In a motor vehicle, pipe connections of the type mentioned here serve, for example, for connecting exhaust pipes of the exhaust system of the motor vehicle. The exhaust pipes are usually connected to each other by means of flanges. To this end, a flange each is welded to the end of an exhaust pipe. The flanges are connected to each other by means of screws, usually incorporating a gasket. Another popular type of connecting the exhaust pipes consists in that the exhaust pipes are directly welded together.

During the course of the new development of motor vehicles the aim is to build the motor vehicles preferably light with respect to weight, in order to achieve a reduction of the fuel consumption and thus a reduction of the pollutant emissions in this manner. Before this background the aim is to embody particularly the exhaust pipes as thin-walled as possible. Thin-walled pipes however can only be welded with increased expenditure.

Therefore, at least one object is proposing a pipe connection for connecting pipes of a motor vehicle with the features mentioned at the outset, through which even thin-walled pipes can be connected to each other in a simple manner. Furthermore, a corresponding exhaust system and an air intake system for a motor vehicle are to be proposed. In addition, a motor vehicle suitable for such a pipe connection is to be proposed. In addition, other objects, desirable features and characteristics will become apparent from the subsequent summary and detailed description, and the appended claims, taken in conjunction with the accompanying drawings and this background.

### SUMMARY

A pipe connection is provided for connecting pipes of a motor vehicle, particularly of exhaust pipes for an exhaust system or intake pipes for the intake tract of a combustion engine comprises two pipes to be connected to each other. The pipes can be exhaust pipes which are employed in the hot region of the motor vehicle. It can also be intake pipes of the intake tract of a combustion engine, via which outside air as so-called combustion air is fed to the combustion engine. At least one of the pipes has a thread which, with a mating thread of a connecting element of the pipe connection that can be connected with the other pipe can be brought into engagement. Preferentially, the other pipe in this case can be connected to the connecting element through positive and/or non-positive connection, particularly connected in a fluid-tight manner.

Through this measure, a connecting of the two pipes without welding is possible in a simple manner. To that extent, the pipe connection is particularly suitable for connecting thin-walled pipes of a motor vehicle. Through the screwing together of the connecting element relative to the one pipe, tolerances in the position of the pipes in axial direction can additionally be flexibly offset, in that the connecting element is screwed together with the pipe comprising the thread to a greater or lesser degree. With such a weld-free pipe connection, it is appropriate that at least one of the pipes is designed in a thin-walled manner.

Thin-walled during the course of the invention is to mean a wall thickness between approximately 0.2 millimeter and approximately 1 millimeter. Preferably, the thin-walled pipe has a wall thickness of approximately 0.8 mm. This wall thickness is an optimal compromise between adequate stability of the pipe and adequate stability especially for exhaust pipes conducting hot exhaust gases. Thin-walled pipes are also relatively light in terms of weight. For the air intake region it is appropriate that the at least one thin-walled pipe has a wall thickness of approximately 0.2 mm. At least one of the pipes or both pipes can consist of plastic and/or metal. Pipes of steel, cast iron, copper, brass are just as conceivable as are such of nickel, titanium and aluminum alloys. Both pipes can also be of a thin-walled design.

According to an embodiment of the pipes at least the pipe with the thread is of a thin-walled design. Because of this, the thread can be formed on the pipe by means of forming in a particularly simple manner.

According to an embodiment it is provided that of the pipes at least the pipe having the thread is a roll form part or at least the thread is formed by means of roll forming. Through the roll forming or roll profiling the pipes can be manufactured highly efficiently with constant quality. The cold hardening of the formed material can also be specifically utilized by means of the cold forming. Through the roll forming it is possible for example that even during the manufacture of the pipe the thread is introduced at the same time and an additional method step is therefore not necessary. By means of the roll forming, thin-walled pipes can be specifically formed. It can also be provided that both pipes or at least the other pipe is a roll formed part or manufactured by means of roll forming.

According to a further embodiment, it is provided that the pipes, clamped together by means of the connecting element, can be connected together. Because of this, the two pipes can be connected together in a fixed manner, so that any possible play and connected with this a minor movement of one of the pipes relative to the other pipe is avoided. In order to be able to establish an optimum connection to the pipes the connecting element should be designed ring-shaped and capable of being pushed onto at least one of the pipes.

Another embodiment provides that the other pipe comprises a collar, flange or protrusion laterally standing away to the outside at least over a circumferential section, against which the connecting element can be moved. Because of this, the other pipe can be connected to the connecting element by means of positive connection so far that pulling out of the other pipe from the connecting element in longitudinal direction is avoided. Here it is appropriate that the collar, flange or protrusion is formed through a widened pipe section, particularly end section of the other pipe. Such a collar, flange or protrusion can be easily realized by means of forming in terms of production. Preferably, the collar, flange or protrusion should be formed through roll forming. Here it is appropriate that at least this region of the other pipe is of a thin-walled design.

According to another embodiment it is provided that the pipe embodied with the thread comprises a bearing surface that corresponds to a mating bearing surface of the collar, flange or protrusion of the other pipe. Through the bearing surface and the mating bearing surface the two pipes specifically meet in predetermined regions, so that because of this a high sealing effect can be achieved when the bearing surface bears against the mating bearing surface. The pipe connection can therefore be employed in this manner without separate sealing element, since in the assembled state of the pipe connection the bearing surfaces meeting in operational position already have an adequately sealing effect. Preferably, the bearing surface of the pipe embodied with the thread should be formed through a formed end section of the pipe. In this manner, the bearing surface can be manufactured particularly easily and cost-effectively.

According to another embodiment it is provided that in the assembled state of the pipe connection the connecting element, subject to bearing against the collar, flange or protrusion of the one pipe, is screwed to the other pipe. Because of this, by means of the connecting element, the two pipes can be brought to bear against each other subject to an effective clamping force, wherein the clamping force is adjustable by screwing the connecting element onto the thread of the one pipe. The connecting element in the process presses against the collar, flange or protrusion of the one pipe. Preferably, the connecting element should be a union nut. Because of this, mass-produced and thus cost-effective connecting elements can be utilized.

The pipe connection makes possible the connecting of pipes of a motor vehicle, without welding having to be carried out in any manner whatsoever for this purpose. For this reason, the pipe connection is particularly suitable for connecting thin-walled pipes. The use of thin-walled pipes in turn offers the advantage that light-weight components can be employed. The pipe connection is also of a particularly compact construction so that compared with pipe connections having flanges, less installation space is required.

In addition to this, because of the thin-walled design of the pipes it is possible that for producing the pipes and for forming the thread or other formative features, roll-forming can be employed, which makes possible manufacturing with large production output with exactly constant quality and maximum efficiency of the components.

An exhaust system is also provided for a motor vehicle with at least one pipe connection of the type described above. An air intake system is provided for a motor vehicle having at least one pipe connection of the type described above. Furthermore, a motor vehicle is provided with at least one pipe connection of the type described above.

### BRIEF DESCRIPTION OF THE DRAWINGS

The present invention will hereinafter be described in conjunction with the following drawing FIGURE showing an possible embodiment of a pipe connection for connecting pipes of a motor vehicle in sectional representation.

### DETAILED DESCRIPTION

The following detailed description is merely exemplary in nature and is not intended to limit application and uses. Furthermore, there is no intention to be bound by any theory presented in the preceding background or summary or the following detailed description.

The only FIGURE shows, in schematic representation, a pipe connection 1, which serves for connecting two pipes 2, 3 of a motor vehicle (not shown). The pipes 2, 3 can for example be exhaust pipes of an exhaust system of the motor vehicle or intake pipes of the intake tract of the combustion engine of a motor vehicle. In the event that the pipes 2, 3 are the exhaust pipes of an exhaust system it is appropriate that the pipe 3 faces the combustion engine (not shown) and the pipe 2 faces the outlet of the exhaust system.

The pipe connection 1 comprises a connecting element 6 by means of which the pipes 2, 3 can be connected at the ends. The pipe 2 to this end comprises a thread 4 which can be brought into engagement with a mating thread 5 of the connecting element 6. The pipe 3 comprises a protrusion 10 laterally standing away to the outside, which is preferably formed over the entire circumference of the pipe 3. The protrusion 10 is preferably formed at an end section of the pipe 3, particularly formed through flaring of the end section of the pipe 3. In the formed state, the protrusion 10 preferably stands obliquely to the outside in the manner that the end of the pipe 3 corresponds to the widened end of the protrusion 10.

The pipe 2 comprises a bearing surface 7 preferably at its end which is arranged downstream of the thread 4, which corresponds to a mating bearing surface 8 of the pipe 3. The bearing surface 7 of the pipe 2 is preferably formed following the thread 4. Here, it can be that the bearing surface 7 is formed through a flank of the thread 4, which for example is extended to the inside or to the outside with regard to the pipe 2. The mating bearing surface 8 of the pipe 3 is preferably formed on the protrusion 10. The bearing surface 7 and the mating bearing surface 8 are designed in a manner that upon a bearing contact of the two surfaces 7, 8 a sealing effect is achieved, so that in bearing contact in the region of the surfaces 7 and 8 the pipe connection 1 is gas and/or liquid-tight.

The connecting element 6, which is preferably a union nut, has a surface section 9 against which the connecting element 6 pushed over the pipe 3 comes to bear and is thus prevented from a further pushing movement in axial direction of the pipe 3. The surface section 9 can be part of a flank of the mating thread 5 of the connecting element 6, which preferentially for enlarging the surface relative to the other flanks of the mating thread 5 can be extended. The surface section 9 can also be a section that is separate relative to the flanks of the mating thread 5. For connecting the pipes 2, 3 the connecting element 6 is pushed on from one of the free ends of the pipe 3 (not shown) in the only FIGURE. It can also be that the connecting element 6 has already been pushed onto the pipe 3 and the end-sided protrusion 10 having been formed only then.

The pipe 3 is aligned in the position relative to the pipe 2 and the connecting element 6 threaded in relative to the end of the pipe 2 comprising the thread 4. The connecting element 6 is then screwed onto the thread 4 of the pipe 2, wherein the surface section 9 of the connecting element 6 presses against the protrusion 10 of the pipe 3 and because of this displaces the pipe 3 so far in axial direction until the protrusion 10 with its mating bearing surface 8 comes to bear against the bearing surface 7 of the pipe 2. By continuing to turn the connecting element 6 into the thread 4 of the pipe 2 clamping of the protrusion 10 of the pipe 3 against the bearing surface 7 of the pipe 2 occurs, as a result of which a fixed and gas or liquid-tight pipe connection 1 of the two pipes 2 and 3 is established.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A pipe connection for connecting pipes of a motor vehicle, comprising:
a connecting element;
a mating thread of the connecting element;
a first pipe comprises a thread brought into engagement with the mating thread of the connecting element; and
a second pipe connected to the first pipe and the mating thread of the connecting element.

2. The pipe connection of claim 1, wherein the connecting pipes are exhaust pipes for an exhaust system.

3. The pipe connection of claim 1, wherein the connecting pipes are intake pipes for an intake tract of a combustion engine

4. The pipe connection according to claim 1, wherein the first pipe is of a thin-walled pipe.

5. The pipe connection according to claim 4, wherein the thin-walled pipe has a wall thickness between approximately 0.2 mm and approximately 1.0 mm.

6. The pipe connection according to claim 4, wherein the thin-walled pipe has a wall thickness of approximately 0.8 mm.

7. The pipe connection according to claim 1, wherein the second pipe is a roll formed part.

8. The pipe connection according to claim 1, wherein the second pipe has at least been formed by roll forming.

9. The pipe connection according to claim 8, wherein the connecting element is ring-shaped that is configured for insertion.

10. The pipe connection according to claim 1, further comprising a pipe collar laterally standing away to an outside over a circumferential section against which the connecting element is movable.

11. The pipe connection according to claim 1, further comprising a pipe flange laterally standing away to an outside over a circumferential section against which the connecting element is movable.

12. The pipe connection according to claim 10, further comprising a pipe protrusion that laterally stands away to an outside over the circumferential section against which the connecting element is movable.

13. The pipe connection according to claim 12, wherein the pipe protrusion is formed by a widened pipe section.

14. The pipe connection according to claim 12, wherein the pipe collar is formed through roll forming.

15. The pipe connection according to claim 12, wherein the second pipe has a bearing surface that corresponds to a mating bearing surface.

16. The pipe connection according to claim 15, wherein the mating bearing surface is formed through a formed end portion of the second pipe.

17. The pipe connection according to claim 12, wherein in an assembled state of the pipe connection, the connecting element is screwed to the first pipe.

18. The pipe connection according to claim 1, wherein the connecting element is a union nut.
